(19) United States
(12) Patent Application Publication
(10) Pub. No.: US 2019/0137407 A1
(43) Pub. Date: May 9, 2019

(54) SURFACE INSPECTION APPARATUS AND METHOD OF INSPECTING SURFACE USING THE SAME

(71) Applicant: SAMSUNG ELECTRONICS CO., LTD., SUWON-SI (KR)

(72) Inventors: WON GUK SEO, GUNPO-SI (KR); KUI HYUN YOON, YONGIN-SI (KR); HAK JUN LEE, HWASEONG-SI (KR)

(21) Appl. No.: 16/013,291

(22) Filed: Jun. 20, 2018

(30) Foreign Application Priority Data
Nov. 8, 2017 (KR) 10-2017-0148253

(51) Int. Cl. G01N 21/88; G01N 21/95

(52) U.S. Cl. CPC G01N 21/8806; G01N 2021/9513; G01N 21/9501

(57) ABSTRACT

A surface inspection apparatus includes a camera that captures an image of an object to be inspected, a half mirror disposed above the camera on a first optical axis, and a light source disposed adjacent to the half mirror on a second optical axis that intersects the first optical axis. The light source radiates light, and the light is directed toward the object to be inspected by the half mirror. The surface inspection apparatus further includes a reflector disposed above the half mirror on the first optical axis. The reflector includes a reflective concave surface that faces toward the object to be inspected.

### CROSS-REFERENCE TO RELATED APPLICATION(S)

This application claims priority under 35 U.S.C. § 119 to Korean Patent Application No. 10-2017-0148253, filed on Nov. 8, 2017, the disclosure of which is incorporated by reference herein in its entirety.

### TECHNICAL FIELD

Exemplary embodiments of the present inventive concept relate to a surface inspection apparatus, and a method of inspecting a surface of an object using the same.

### DISCUSSION OF THE RELATED ART

The use of flat panel display devices such as, for example, organic light-emitting diode (OLED) displays, liquid crystal displays (LCDs), electrophoretic displays (EPDs), and plasma display panels (PDPs), has recently been increasing. These flat panel display devices may be implemented as flexible display devices.

Flexible substrates may be used to implement flexible display devices. Various types of foreign substances may be deposited on these flexible substrates, and defects may be formed in the surfaces of these flexible substrates during manufacturing or handling processes.

### SUMMARY

Exemplary embodiments of the present inventive concept provide a surface inspection apparatus that efficiently inspects a surface of an object such as, for example, a curved film/substrate.

According to an exemplary embodiment of the inventive concept, a surface inspection apparatus includes a first camera that captures an image of an object to be inspected, a half mirror disposed above the first camera on a first optical axis, and a light source disposed adjacent to the half mirror on a second optical axis that intersects the first optical axis. The light source radiates light, and the light is directed toward the object to be inspected by the half mirror. The surface inspection apparatus further includes a reflector disposed above the half mirror on the first optical axis. The reflector includes a reflective concave surface that faces toward the object to be inspected.

According to an exemplary embodiment of the inventive concept, a surface inspection apparatus includes a reflector having an opening, and a light source disposed below the reflector. The light source radiates light in a horizontal direction. The surface inspection apparatus further includes a half mirror disposed on one side of the light source. The half mirror reflects a portion of the light radiated by the light source in a vertical direction, such that the portion of the light is incident through the opening to a surface of an object to be inspected disposed above the reflector. The surface inspection apparatus further includes a first camera disposed below the reflector. The first camera receives light reflected from a surface of the object to be inspected. The object to be inspected, the opening, and the half mirror are disposed on an optical axis of the camera.

According to an exemplary embodiment of the inventive concept, a surface inspection method includes mounting an object to be inspected having a curved surface above a reflector of a surface inspection apparatus. The reflector includes a reflective concave surface that faces toward the object to be inspected. The method further includes radiating light toward the curved surface of the object to be inspected. The light is radiated by a light source of the surface inspection apparatus, and the light is directed toward the curved surface of the object to be inspected by a half mirror of the surface inspection apparatus. The half mirror and the reflector are disposed on an optical axis of a first camera of the surface inspection apparatus. The method further includes obtaining information relating to a location of the curved surface of the object to be inspected, and capturing an image of the curved surface of the object to be inspected using the first camera of the surface inspection apparatus.

According to an exemplary embodiment of the inventive concept, a method of manufacturing a display device includes forming the display device, which includes a substrate, and inspecting the substrate. Inspecting the substrate includes mounting the substrate above a reflector of a surface inspection apparatus. The reflector includes a reflective concave surface that faces toward the substrate. Inspecting the substrate further includes radiating light toward the substrate. The light is radiated by a light source of the surface inspection apparatus, and the light is directed toward the substrate by a half mirror of the surface inspection apparatus. The half mirror and the reflector are disposed on an optical axis of a camera of the surface inspection apparatus. Inspecting the substrate further includes obtaining information relating to a location of the substrate, and capturing an image of the substrate using the camera of the surface inspection apparatus.

### BRIEF DESCRIPTION OF THE DRAWINGS

The above and other features of the present inventive concept will become more apparent by describing in detail exemplary embodiments thereof with reference to the accompanying drawings, in which:

FIG. 1 is a diagram of a surface inspection apparatus according to an exemplary embodiment of the inventive concept.

FIG. 2 illustrates a reflector according to an exemplary embodiment of the inventive concept.

FIG. 3A illustrates a reflector according to an exemplary embodiment of the inventive concept.

FIG. 3B is a cross-sectional view taken along line I-I′ of FIG. 3A according to an exemplary embodiment of the inventive concept.

FIG. 3C is a cross-sectional view taken along line II-II′ of FIG. 3A according to an exemplary embodiment of the inventive concept.

FIG. 4A illustrates a reflector according to an exemplary embodiment of the inventive concept.

FIG. 4B is a cross-sectional view taken along line III-III′ of FIG. 4A according to an exemplary embodiment of the inventive concept.

FIG. 5A illustrates an object to be inspected by a surface inspection apparatus according to an exemplary embodiment of the inventive concept.

FIG. 5B is a cross-sectional view taken along line I-I′ of FIG. 5A according to an exemplary embodiment of the inventive concept.

FIG. 6 is a flowchart illustrating a method of inspecting an object to be inspected using a surface inspection apparatus according to an exemplary embodiment of the inventive concept.

FIGS. 7 and 8 illustrate a method of inspecting an object to be inspected using a surface inspection apparatus according to an exemplary embodiment of the inventive concept.

FIG. 9 is a diagram of a surface inspection apparatus according to an exemplary embodiment of the inventive concept.

### DETAILED DESCRIPTION OF THE EXEMPLARY EMBODIMENTS

Exemplary embodiments of the present inventive concept will be described more fully hereinafter with reference to the accompanying drawings. Like reference numerals may refer to like elements throughout the accompanying drawings.

Spatially relative terms, such as “beneath”, “below”, “lower”, “under”, “above”, “upper”, etc., may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below.

It will be understood that the terms “first,” “second,” “third,” etc. are used herein to distinguish one element from another, and the elements are not limited by these terms. Thus, a “first” element in an exemplary embodiment may be described as a “second” element in another exemplary embodiment.

Herein, when two or more elements or values are described as being substantially the same as or about equal to each other, it is to be understood that the elements or values are identical to each other, indistinguishable from each other, or distinguishable from each other but functionally the same as each other as would be understood by a person having ordinary skill in the art.

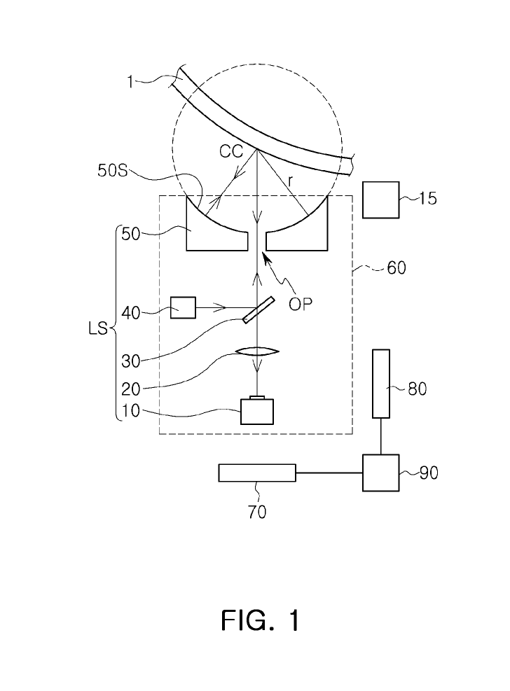

FIG. 1 is a diagram of a surface inspection apparatus according to an exemplary embodiment of the inventive concept.

Referring to FIG. 1, in an exemplary embodiment, a surface inspection apparatus includes a camera 10, a lens 20, a half mirror 30, a light source 40, a reflector 50, a support frame 60, a horizontal driving part 70, and a vertical driving part 80. The camera 10, the lens 20, the half mirror 30, the light source 40, and the reflector 50 may be collectively referred to as an optical system LS. The horizontal driving part 70 and the vertical driving part 80 may be collectively referred to as a driving unit. In an exemplary embodiment, the driving unit is a motorized unit including a motor that moves the support frame 60. In an exemplary embodiment, the horizontal driving part 70 is a first motorized unit including a first motor that moves the support frame 60 in a horizontal direction, and the vertical driving part 80 is a second motorized unit including a second motor that moves the support frame 60 in a vertical direction.

An object to be inspected 1 may be mounted on an inspection location of the optical system LS, and the optical system LS may inspect a surface of the object to be inspected 1. For example, in an exemplary embodiment, the object to be inspected 1 is mounted on the reflector 50 of the optical system LS. Thus, in an exemplary embodiment, the reflector 50 is the inspection location of the optical system LS.

The camera 10 captures an image of the mounted object to be inspected 1. The captured image may be inspected to detect, for example, foreign substances or defects on the surface of the object to be inspected 1.

In an exemplary embodiment, the lens 20, the half mirror 30, and the reflector 50 are sequentially disposed on an optical axis of the camera 10 in a substantially straight line. For example, in an exemplary embodiment, center portions of the lens 20, the half mirror 30, and the reflector 50 are substantially aligned with one another along the optical axis of the camera 10. Herein, the term substantially aligned means that the components are exactly aligned with one another, or are almost exactly aligned with one another as would be understood by a person having ordinary skill in the art. The reflector 50 is disposed above the camera 10, and the object to be inspected 1 is disposed above the reflector 50. The optical axis of the camera 10 may also be referred to herein as a first optical axis or a vertical optical axis.

An optical axis of the light source 40 intersects the optical axis of the camera 10 (e.g., the first optical axis). The optical axis of the light source 40 may also be referred to herein as a second optical axis or a horizontal optical axis. In an exemplary embodiment, the half mirror 30 is disposed at an intersection between the first optical axis and the second optical axis, as shown in FIG. 1. The light source 40 is disposed below the reflector 50 and adjacent to the half mirror 30, and radiates light in a horizontal direction. For example, the light source 40 radiates light in a direction toward the half mirror 30, and the half mirror 30 directs the light toward the object to be inspected 1. For example, the half mirror 30, which is disposed on one side of the light source 40, may reflect a portion of the light emitted by the light source 40 in a vertical direction, such that the portion of the light is incident to the object to be inspected 1. The light source 40 may be, for example, a variable light source capable of adjusting the brightness of light according to, for example, the transmissivity or reflectivity of the object to be inspected 1. The light source 40 may include at least one lens. For example, in an exemplary embodiment, the lens included in the light source 40 may be provided as a plurality of lenses.

In an exemplary embodiment, the reflector 50 has a reflective concave surface 50S that faces in a direction toward the object to be inspected 1, as shown in FIG. 1. The surface of the object to be inspected 1 may have a downwardly convex curved surface.

The surface of the object to be inspected 1 may be positioned substantially at a center of curvature CC of the reflector 50. Herein, when the object to be inspected 1 is described as being positioned substantially at a center of curvature CC of the reflector 50, it is to be understood that the object to be inspected 1 is positioned exactly at the center of curvature CC of the reflector 50, or almost exactly at the center of curvature CC of the reflector 50 within a measurement error as would be understood by a person having ordinary skill in the art. In an exemplary embodiment, a distance from the reflective concave surface 50S of the reflector 50 to the surface of the object to be inspected 1 is about the same (e.g., exactly the same, or about the same within a measurement error as would be understood by a person having ordinary skill in the art) as a radius of curvature r of the reflector 50. At least a portion of the light incident to the object to be inspected 1 may be reflected from the surface of the object to be inspected 1. The reflector 50 enables the light reflected from the surface of the object to be inspected 1 that is inclined with respect to the optical axis of the camera 10 to be incident to the camera 10. When the surface of the object to be inspected 1 is positioned substantially at the center of curvature CC of the reflector 50, the light that is primarily reflected from the surface of the object to be inspected 1 that is inclined with respect to the optical axis of the camera 10 may be secondarily reflected from the reflective concave surface 50S of the reflector 50 to be reincident to the surface of the object to be inspected 1. The reincident light may be tertiarily reflected from the surface of the object to be inspected 1 to be incident to the camera 10 along the optical axis of the camera 10, forming an image. In a case in which the reflector 50 is not present, the light primarily reflected from the inclined surface of the object to be inspected 1 is not incident to the camera 10, and thus, an image is not formed. In a case in which the reflector 50 is present, but the reflector 50 is not positioned substantially at the center of curvature CC, the light primarily reflected from the inclined surface of the object to be inspected 1 is not incident to the camera 10, and thus, an image is not formed.

In an exemplary embodiment, the reflector 50 includes an opening OP disposed on the optical axis of the camera 10 (e.g., the first optical axis), allowing light to pass through the reflector 50. For example, in an exemplary embodiment, the opening OP of the reflector 50 is substantially aligned with center portions of the half mirror 30, the lens 20, and the camera 10 along the optical axis of the camera 10.

In an exemplary embodiment, the camera 10, the lens 20, the half mirror 30, the light source 40, and the reflector 50 are attached to the support frame 60. For example, the support frame 60 supports (e.g., structurally supports) the camera 10, the lens 20, the half mirror 30, the light source 40, and the reflector 50.

In an exemplary embodiment, the horizontal driving part 70 moves the support frame 60 in a horizontal direction, and the vertical driving part 80 moves the support frame 60 in a vertical direction. The vertical driving part 80 may adjust a vertical location of the support frame 60 to position the surface of the object to be inspected 1 substantially at the center of curvature CC of the reflector 50. The horizontal driving part 70 may adjust the support frame 60 in the horizontal direction such that an image of the surface of the object to be inspected 1 may be captured. In an exemplary embodiment, the surface inspection apparatus controls the horizontal driving part 70 and the vertical driving part 80 to capture an image of an entirety of the surface of the object to be inspected 1, while holding the surface of the object to be inspected 1 at the center of curvature CC of the reflector 50.

The camera 10 may be, for example, a time delay integration (TDI) line scan camera.

According to exemplary embodiments, various types of image capturing means such as, for example, an area scan camera used in the surface inspection apparatus, may be used as the camera 10.

In an exemplary embodiment, the surface inspection apparatus includes a position measuring unit 15 that obtains information relating to a location of the surface of the object to be inspected 1. For example, the surface inspection apparatus may obtain information relating to a vertical location of the surface of the object to be inspected 1 using the position measuring unit 15. The position measuring unit 15 may be, for example, a camera. According to exemplary embodiments, the position measuring unit 15 may be attached to the support frame 60, or may be attached to a support unit that is capable of being driven independently of the support frame 60.

In an exemplary embodiment, the surface inspection apparatus further includes a controller 90 that controls the horizontal driving part 70 and the vertical driving part 80. In an exemplary embodiment, the controller 90 controls the light source 40. In an exemplary embodiment, the controller 90 includes a memory that stores instructions that cause the horizontal driving part 70 and the vertical driving part 80 to move, and a processor that executes the instructions.

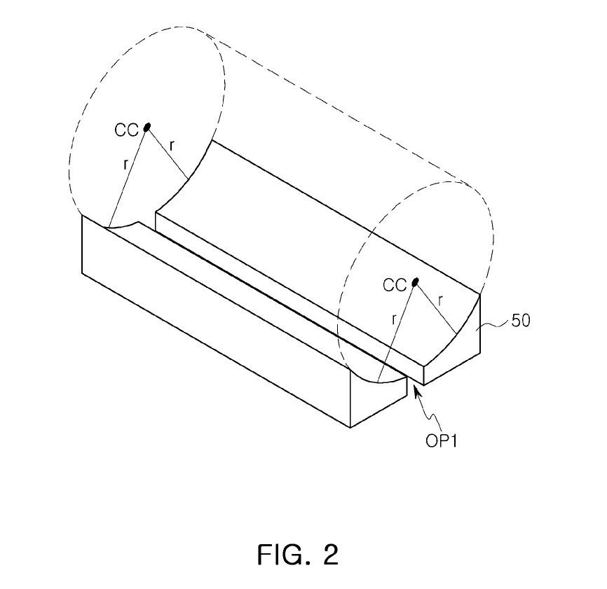

FIG. 2 illustrates a reflector 50 according to an exemplary embodiment of the inventive concept.

Referring to FIG. 2, in an exemplary embodiment, the reflector 50 has a reflective cylindrical surface. The reflector 50 includes an opening OP1 disposed on the optical axis of the camera 10 (e.g., the first optical axis).

The reflector 50 is divided into two parts by the opening OP1. The two parts have about the same radius of curvature r and about the same center of curvature CC as each other. Herein, when the two parts are described as having about the same radius of curvature r or about the same center of curvature CC as each other, it is to be understood that the radius of curvature r or the center of curvature CC are identical to each other, indistinguishable from each other, or distinguishable from each other but functionally the same as each other as would be understood by a person having ordinary skill in the art.

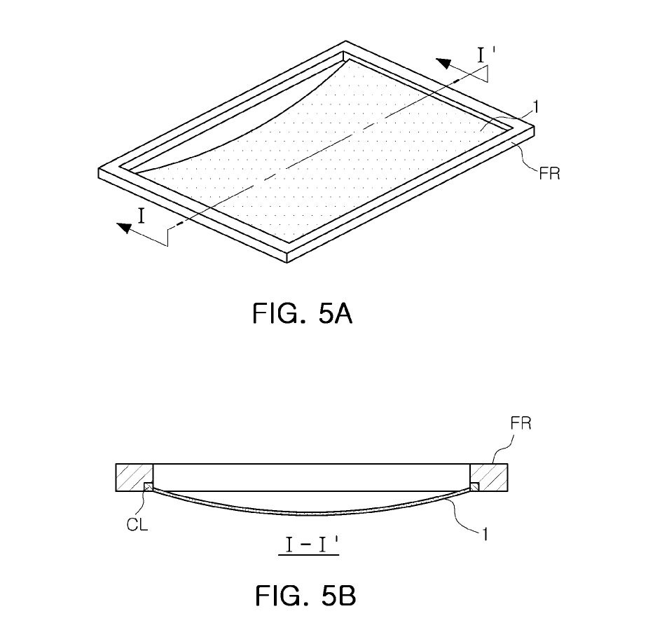

The reflector 50 extends in a first direction. The length of the reflector 50 extending in the first direction may be about the same as the length of one side of the object to be inspected 1. The length of the side of the object to be inspected 1 may refer to that of a side thereof fixed to a frame FR (see FIG. 5).

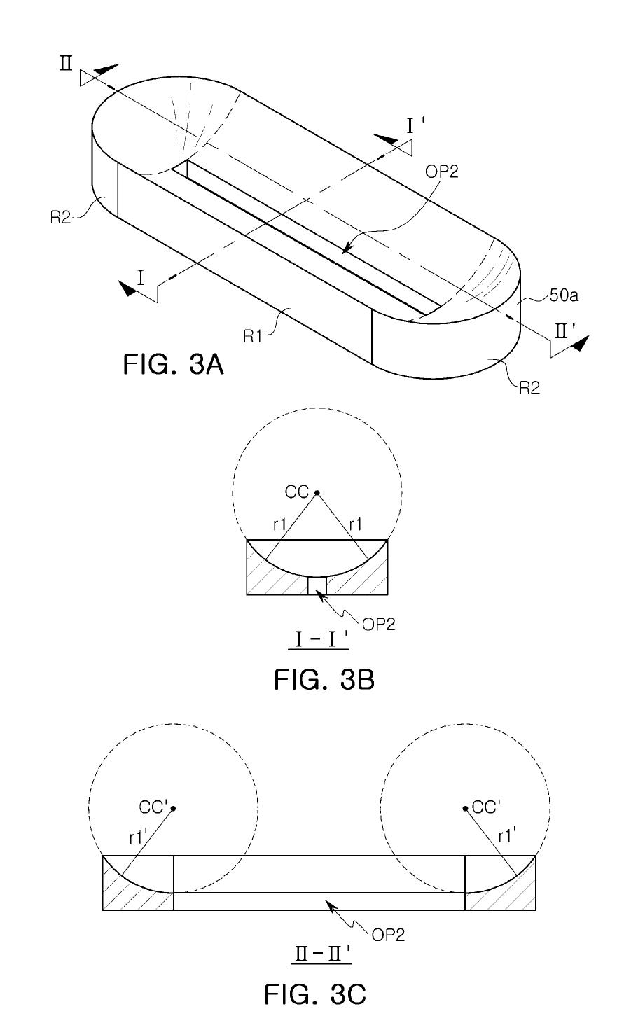

FIG. 3A illustrate a reflector 50a according to an exemplary embodiment of the inventive concept. FIG. 3B is a cross-sectional view taken along line I-I′ of FIG. 3A according to an exemplary embodiment of the inventive concept. FIG. 3C is a cross-sectional view taken along line II-II′ of FIG. 3A according to an exemplary embodiment of the inventive concept.

Referring to FIGS. 3A-3C, in an exemplary embodiment, a reflector 50a includes a first region R1 having a reflective cylindrical surface, and second regions R2 disposed on opposite ends of the first region R1 and having a reflective spherical surface. The first region R1 includes an opening OP2 disposed on the optical axis of the camera 10 (e.g., the first optical axis). The first region R1 has a center of curvature CC, and the second regions R2 have a center of curvature CC′.

A radius of curvature r1 of the first region R1 is about the same as a radius of curvature r1′ of the second regions R2.

The first region R1 extends in the first direction. The length of the first region R1 extending in the first direction may be about the same as that of one side of the object to be inspected 1.

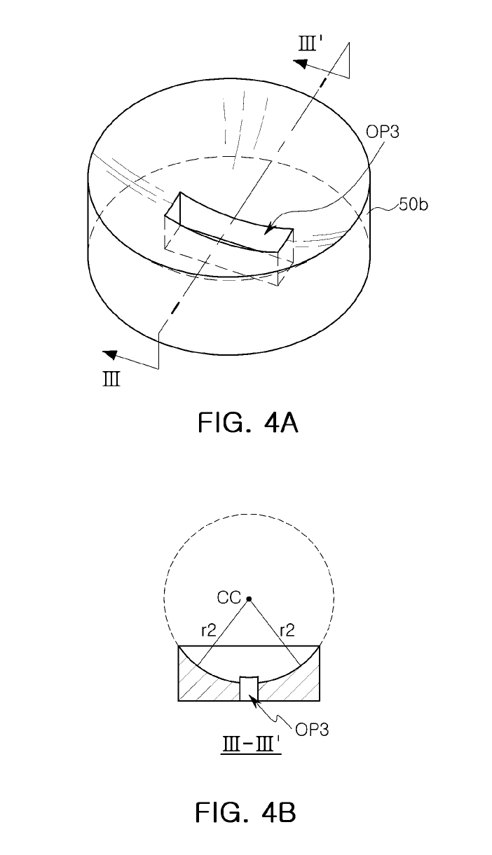

FIG. 4A illustrates a reflector 50b according to an exemplary embodiment of the inventive concept. FIG. 4B is a cross-sectional view taken along line III-III of FIG. 4A according to an exemplary embodiment of the inventive concept.

Referring to FIGS. 4A and 4B, in an exemplary embodiment, a reflector 50b has a reflective spherical surface. The reflector 50b includes an opening OP3 disposed on the optical axis of the camera 10 (e.g., the first optical axis). The opening OP3 extends in a first direction. The reflector 50b has a radius of curvature r2 and a center of curvature CC.

FIG. 5A illustrates an object to be inspected 1 by a surface inspection apparatus according to an exemplary embodiment of the inventive concept. FIG. 5B is a cross-sectional view taken along line I-I′ of FIG. 5A according to an exemplary embodiment of the inventive concept.

Referring to FIGS. 5A and 5B, in an exemplary embodiment, the object to be inspected 1 is mounted on an inspection location on the surface inspection apparatus while being fixed to the frame FR. The frame FR has a quadrangular shape. The object to be inspected 1 may be, for example, a flexible substrate. Two of four sides of the object to be inspected 1 may be clamped to the frame FR by a clamp CL. In an exemplary embodiment, the object to be inspected 1 is bent downwardly. Accordingly, the object to be inspected 1 may have a downwardly convex curved surface. In an exemplary embodiment, four sides of the object to be inspected 1 are fixed to the frame FR.

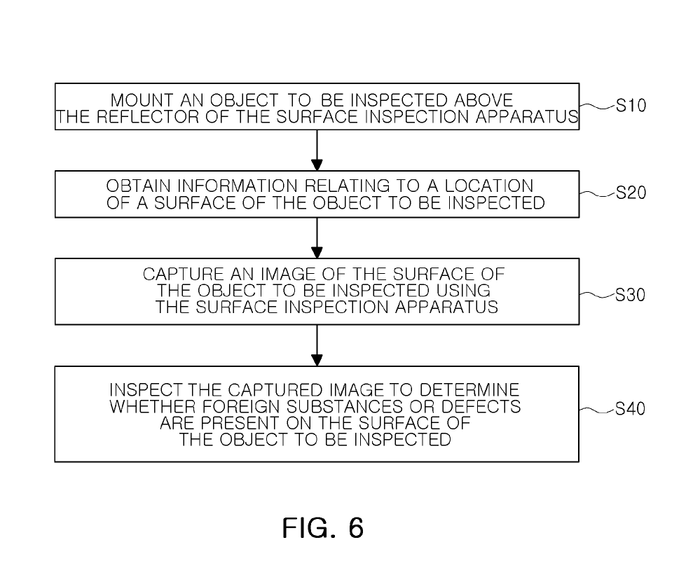

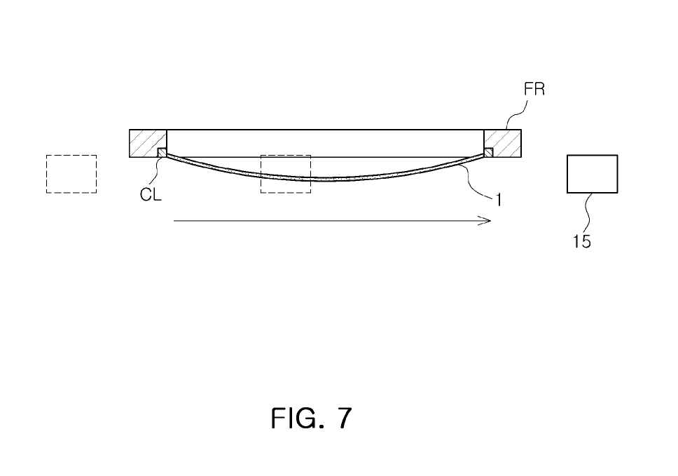

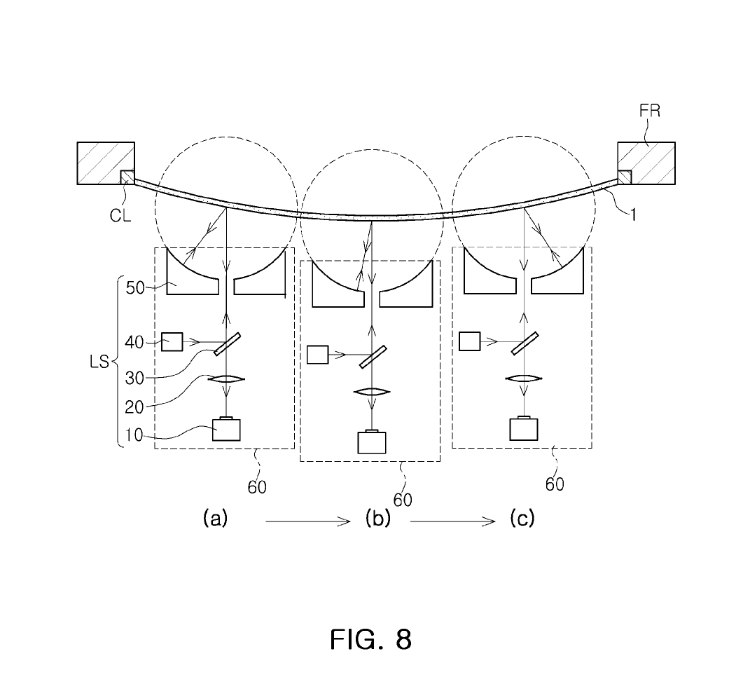

FIG. 6 is a flowchart illustrating a method of inspecting an object to be inspected 1 using a surface inspection apparatus according to an exemplary embodiment of the inventive concept. FIGS. 7 and 8 illustrate a method of inspecting an object to be inspected 1 using a surface inspection apparatus according to an exemplary embodiment of the inventive concept.

Referring to FIG. 6, in an exemplary embodiment, a method of inspecting a surface of the object to be inspected 1 using the surface inspection apparatus according to the exemplary embodiments described herein includes mounting the object to be inspected 1 above the reflector 50 of the surface inspection apparatus (S10), obtaining information relating to a location of the surface of the object to be inspected 1 (S20), capturing an image of the surface of the object to be inspected 1 using the surface inspection apparatus (S30), and inspecting the captured image to determine whether foreign substances or defects are present on the surface of the object to be inspected 1 (S40).

FIG. 7 illustrates obtaining information relating to the location of the surface of the object to be inspected 1 (S20) using a position measuring unit 15 (e.g., a camera) according to an exemplary embodiment of the inventive concept.

In an exemplary embodiment, the position measuring unit 15 captures an image of the object to be inspected 1 while moving in a horizontal direction on a lateral surface of the object to be inspected 1. The surface inspection apparatus may analyze the captured image to obtain information (for example, information indicating a height from a reference surface) relating to a vertical location of the surface of the object to be inspected 1. Further, the surface inspection apparatus may analyze the captured image to obtain information (for example, information indicating a size of a scanned region) relating to a horizontal length of the surface of the object to be inspected 1.

FIG. 8 illustrates capturing the image of the surface of the object to be inspected 1 using the surface inspection apparatus (S30) according to an exemplary embodiment of the inventive concept.

In an exemplary embodiment, capturing an image of the surface of the object to be inspected 1 includes adjusting a vertical location of the reflector 50 using the information relating to the location of the surface of the object to be inspected 1 obtained by the position measuring unit 15, such that the surface of the object to be inspected 1 is positioned substantially at a center of curvature of the reflector 50. Capturing the image further includes radiating, by the light source 40, light to the surface of the object to be inspected 1 through the opening OP of the reflector 50, and receiving, by the camera 10, light primarily reflected from the surface of the object to be inspected 1, light secondarily reflected from a reflective surface of the reflector 50, and light tertiarily reflected from the surface of the object to be inspected 1. Capturing the image further includes horizontally moving the support frame 60.

As illustrated in FIG. 8, the object to be inspected 1 may have a downwardly convex curved surface. Thus, the vertical location of the reflector 50 may be lowered and then raised while the object to be inspected 1 is scanned from one side to the other side thereof. The vertical location of the reflector 50 may be determined by adjusting the location of the support frame 60.

The surface inspection apparatus may analyze a first image of the object to be inspected 1 obtained through the preceding surface inspection operation, and when a dark region is present on the first image, the surface inspection apparatus may control the light source 40 to emit brighter light while capturing an image of a portion of the surface of the object to be inspected 1 corresponding to the dark region. For example, the transmissivity of the object to be inspected 1 may be greater or the reflectivity thereof may be lower in a location (a) or (c) at which the surface of the object to be inspected 1 is further inclined, as illustrated in FIG. 8. When the surface inspection apparatus captures an image of the surface of the object to be inspected 1 at the location (a) or (c) at which the surface of the object to be inspected 1 is further inclined, the surface inspection apparatus may control the light source 40 to emit light brighter than that of the light source 40 when capturing an image of the surface of the object to be inspected 1 at a location (b). When varying the brightness of the light source 40, the surface inspection apparatus may obtain an inspection image having further uniform brightness. As a result, inspection reliability for foreign substances and defects present on the surface of the object to be inspected 1 may be increased.

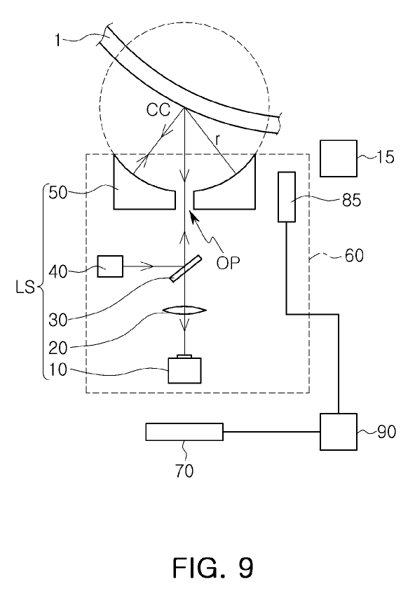

FIG. 9 is a diagram of a surface inspection apparatus according to an exemplary embodiment of the inventive concept.

The surface inspection apparatus illustrated in FIG. 9 includes a vertical driving part 85 that moves only the reflector 50 in a vertical direction, such that the surface of the object to be inspected 1 may be positioned substantially at the center of curvature CC of the reflector 50. In an exemplary embodiment, the vertical driving part 85 is attached to the support frame 60, and the reflector 50 is attached to the vertical driving part 85.

The horizontal driving part 70 moves the support frame 60 in a horizontal direction on the surface of the object to be inspected 1, and a controller 90 controls the vertical driving part 85 and the horizontal driving part 70.

The object to be inspected may be, for example, a substrate (e.g., a flexible substrate) used to manufacture a display device. According to an exemplary embodiment of the inventive concept, a method of manufacturing a display device includes forming the display device, which includes the substrate 1, and inspecting the substrate 1 using the surface inspection apparatus and method according to the exemplary embodiments of the inventive concept described herein.

As set forth above, according to exemplary embodiments of the present inventive concept, a surface inspection apparatus and a method of inspecting a surface using the same efficiently inspects a surface of an object to be inspected having a curved surface, thus increasing inspection reliability.

While the present inventive concept has been particularly shown and described with reference to the exemplary embodiments thereof, it will be understood by those skilled in the art that various changes in form and detail may be made therein without departing from the spirit and scope of the present inventive concept as defined by the following claims.

1. A surface inspection apparatus, comprising:
a first camera that captures an image of an object to be inspected;
a half mirror disposed above the first camera on a first optical axis;
a light source disposed adjacent to the half mirror on a second optical axis that intersects the first optical axis,
wherein the light source radiates light, and the light is directed toward the object to be inspected by the half mirror; and
a reflector disposed above the half mirror on the first optical axis,
wherein the reflector comprises a reflective concave surface that faces toward the object to be inspected.

2. The surface inspection apparatus of claim 1, wherein a distance from the reflective concave surface of the reflector to a surface of the object to be inspected is about the same as a radius of curvature of the reflector.

3. The surface inspection apparatus of claim 1, wherein the reflector has a reflective cylindrical surface.

4. The surface inspection apparatus of claim 3, wherein the reflector comprises an opening disposed on the first optical axis.

5. The surface inspection apparatus of claim 4, wherein the reflector is divided into two parts by the opening, and the two parts have about the same radius of curvature and about the same center of curvature as each other.

6. The surface inspection apparatus of claim 1, wherein the reflector comprises a first region having a reflective cylindrical surface, and second regions disposed on opposite ends of the first region and having reflective spherical surfaces.

7. The surface inspection apparatus of claim 6, wherein the reflector comprises an opening disposed on the first optical axis.

8. The surface inspection apparatus of claim 1, wherein the reflector is disposed above the first camera, the object to be inspected is disposed above the reflector, and a surface of the object to be inspected has a downwardly concave curved surface.

9. The surface inspection apparatus of claim 1, wherein a brightness of the light source is adjustable according to transmissivity of the object to be inspected.

10. The surface inspection apparatus of claim 1, further comprising:
a second camera that obtains information relating to a location of a surface of the object to be inspected;
a support frame that supports the first camera, the half mirror, the light source, and the reflector;
a driving unit that moves the support frame; and
a controller that controls the driving unit.

11. The surface inspection apparatus of claim 10, wherein the driving unit comprises:
a vertical driving part that adjusts a vertical location of the support frame to position the surface of the object to be inspected substantially at a center of curvature of the reflector; and
a horizontal driving part that moves the support frame in a horizontal direction.

12. The surface inspection apparatus of claim 1, further comprising:
a second camera that obtains information relating to a location of a surface of the object to be inspected;
a support frame that supports the first camera, the half mirror, the light source, and the reflector;
a vertical driving part that moves the reflector in a vertical direction such that the surface of the object to be inspected is positioned substantially at a center of curvature of the reflector;
a horizontal driving part that moves the support frame in a horizontal direction along the surface of the object to be inspected; and
a controller that controls the vertical driving part and the horizontal driving part.

13. A surface inspection apparatus, comprising:
a reflector having an opening;
a light source disposed below the reflector, wherein the light source radiates light in a horizontal direction;
a half mirror disposed on one side of the light source,
wherein the half mirror reflects a portion of the light radiated by the light source in a vertical direction, such that the portion of the light is incident through the opening to a surface of an object to be inspected disposed above the reflector; and
a first camera disposed below the reflector, wherein the first camera receives light reflected from a surface of the object to be inspected,
wherein the object to be inspected, the opening, and the half mirror are disposed on an optical axis of the first camera.

14. The surface inspection apparatus of claim 13, wherein the reflector has a reflective concave surface that faces toward the object to be inspected, and a distance from the reflective concave surface of the reflector to the surface of the object to be inspected is about the same as a radius of curvature of the reflector.

15. The surface inspection apparatus of claim 14, wherein the reflector has a reflective cylindrical surface.

16. The surface inspection apparatus of claim 15, wherein the reflector is divided into two parts by the opening, and the two parts have about the same radius of curvature and about the same center of curvature as each other.

17. The surface inspection apparatus of claim 14, wherein the reflector comprises a first region having a reflective cylindrical surface, and second regions disposed on opposite ends of the first region and having reflective spherical surfaces.

18. The surface inspection apparatus of claim 13, further comprising:
a second camera that obtains information relating to a location of the surface of the object to be inspected;
a support frame that supports the first camera, the half mirror, the light source, and the reflector;
a driving unit that moves the support frame; and
a controller that controls the driving unit.

19. The surface inspection apparatus of claim 18, wherein the driving unit comprises:
a vertical driving part that adjusts a vertical location of the support frame to position the surface of the object to be inspected substantially at a center of curvature of the reflector; and
a horizontal driving part that moves the support frame in the horizontal direction.

20. The surface inspection apparatus of claim 13, further comprising:
a second camera that obtains information relating to a location of the surface of the object to be inspected;
a support frame that supports the first camera, the half mirror, the light source, and the reflector;
a vertical driving part that moves the reflector in the vertical direction, such that the surface of the object to be inspected is positioned substantially at a center of curvature of the reflector;
a horizontal driving part that moves the support frame in the horizontal direction along the surface of the object to be inspected; and
a controller that controls the vertical driving part and the horizontal driving part.

21-25. (canceled)
